(19) United States
(12) Patent Application Publication
(10) Pub. No.: US 2006/0260311 A1
(43) Pub. Date: Nov. 23, 2006

(54) Wind generating and storage system with a windmill station that has a pneumatic motor and its methods of use

(76) Inventor: Eric Ingersoll, Cambridge, MA (US)

Correspondence Address: HELLER EHRMAN LLP, 275 MIDDLEFIELD ROAD, MENLO PARK, CA, 94025-3506, US

(21) Appl. No.: 11/437,406

(22) Filed: May 19, 2006

Related U.S. Application Data
(63) Continuation-in-part of application No. 10/744,232, filed on Dec. 22, 2003.

(51) Int. Cl. F03G 7/00

(52) U.S. Cl. 60/641.1

(57) ABSTRACT

A wind energy generating and storage system includes at least one direct compression windmill station that with a pneumatic motor. Direct compression is direct rotational motion of a shaft or a rotor coupled to one or more compressors. A storage device coupled to the windmill station. At least a first compressor is coupled to the storage device to compress or liquefy air, or to drive any process to make liquefied air. The compressor has a fluid intake opening and a fluid exhaust opening. Rotation of a turbine drives the compressor. At least one expander is provided that releases compressed or liquid air from the storage device. A generator converts the compressed or liquid air energy into electrical energy.

### RELATED APPLICATIONS

This application is a continuation-in-part of U.S. Ser. No. 10/744,232, filed Dec. 22, 2003, which application is fully incorporated herein by reference.

### BACKGROUND

1. Field of the Invention

This invention relates generally to a wind generating and storage system, and its methods of use, and more particularly to a wind generating and storage system, and its methods of use, that has at least one windmill station with a pneumatic motor.

2. Description of the Related Art

From its commercial beginnings more than twenty years ago, wind energy has achieved rapid growth as a technology for the generation of electricity. The current generation of wind technology is considered mature enough by many of the world's largest economies to allow development of significant electrical power generation. By the end of 2005 more than 59,000 MW of windpower capacity had been installed worldwide, with annual industry growth rates of greater than 25% experienced during the last five years.

Certain constraints to the widespread growth of windpower have been identified. Many of these impediments relate to the fact that in many cases, the greatest wind resources are located far from the major urban or industrial load centers. This means the electrical energy harvested from the areas of abundant wind must be transmitted to areas of great demand, often requiring the transmission of power over long distances.

Transmission and market access constraints can significantly affect the cost of wind energy. Varying and relatively unpredictable wind speeds affect the hour to hour output of wind plants, and thus the ability of power aggregators to purchase wind power, such that costly and/or burdensome requirements can be imposed upon the deliverer of such varying energy. Congestion costs are the costs imposed on generators and customers to reflect the economic realities of congested power lines or “Bottlenecks.” Additionally, interconnection costs based upon peak usage are spread over relatively fewer kwhs from intermittent technologies such as windpower as compared to other technologies.

Power from existing and proposed offshore windplants is usually delivered to the onshore loads after stepping up the voltage for delivery through submarine high voltage cables. The cost of such cables increases with the distance from shore. Alternatives to the high cost of submarine cables are currently being contemplated. As in the case of land-based windplants with distant markets, there will be greatly increased costs as the offshore windpower facility moves farther from the shore and the load centers. In fact, the increase in costs over longer distance may be expected to be significantly higher in the case of offshore windplants. It would thus be advisable to develop alternative technologies allowing for the transmission of distant offshore energy such as produced by windpower.

A need exists, for example, to provide improved wind generating and storage system, and its methods of use, that has at least one direct compression windmill station with a pneumatic motor.

### SUMMARY

Accordingly, an object of the present invention is to provide an improved wind generating and storage system, as well as its methods of use.

Another object of the present invention is to provide an improved wind generating and storage system, and its methods of use, that has at least one windmill station with a pneumatic motor.

These and other objects of the present invention are achieved in, a wind energy generating and storage system that includes at least one direct compression windmill station that with a pneumatic motor. Direct compression is direct rotational motion of a shaft or a rotor coupled to one or more compressors. A storage device coupled to the windmill station. At least a first compressor is coupled to the storage device to compress or liquefy air, or to drive any process to make liquefied air. The compressor has a fluid intake opening and a fluid exhaust opening. Rotation of a turbine drives the compressor. At least one expander is provided that releases compressed or liquid air from the storage device. A generator converts the compressed or liquid air energy into electrical energy.

In another embodiment of the present invention, a method of production, collects wind energy from a direct compression windmill station that includes a pneumatic motor. Air is compressing or liquefied from the wind energy utilizing a compressor. An expander releases compressed or liquid air. The compressed or liquid air energy is converted into electrical energy.

### BRIEF DESCRIPTION OF THE DRAWINGS

FIG. 1(a) illustrates one embodiment of a wind energy and storage system of the present invention.

FIG. 1(b) illustrates one embodiment of a wind energy and storage system of the present invention with a multi-stage compressor

FIG. 2 illustrates one embodiment of a toroidal intersecting vane compressor that can be used with the present invention.

### DETAILED DESCRIPTION

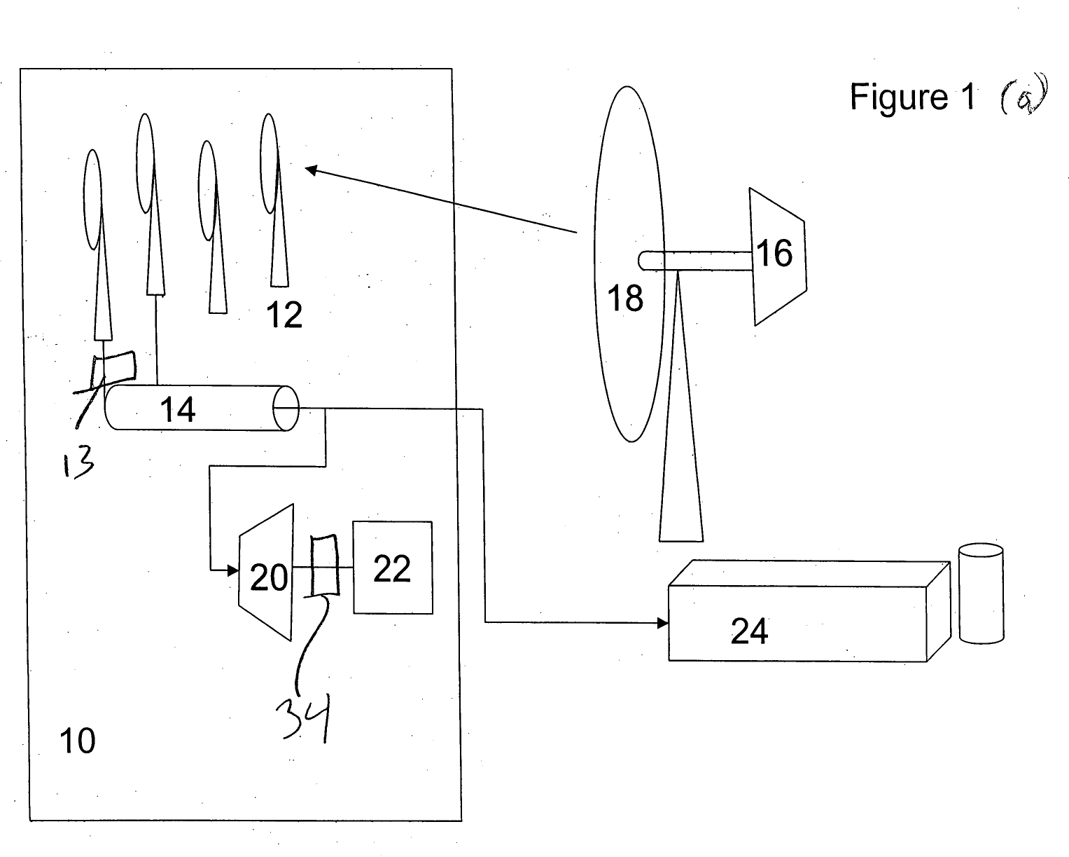

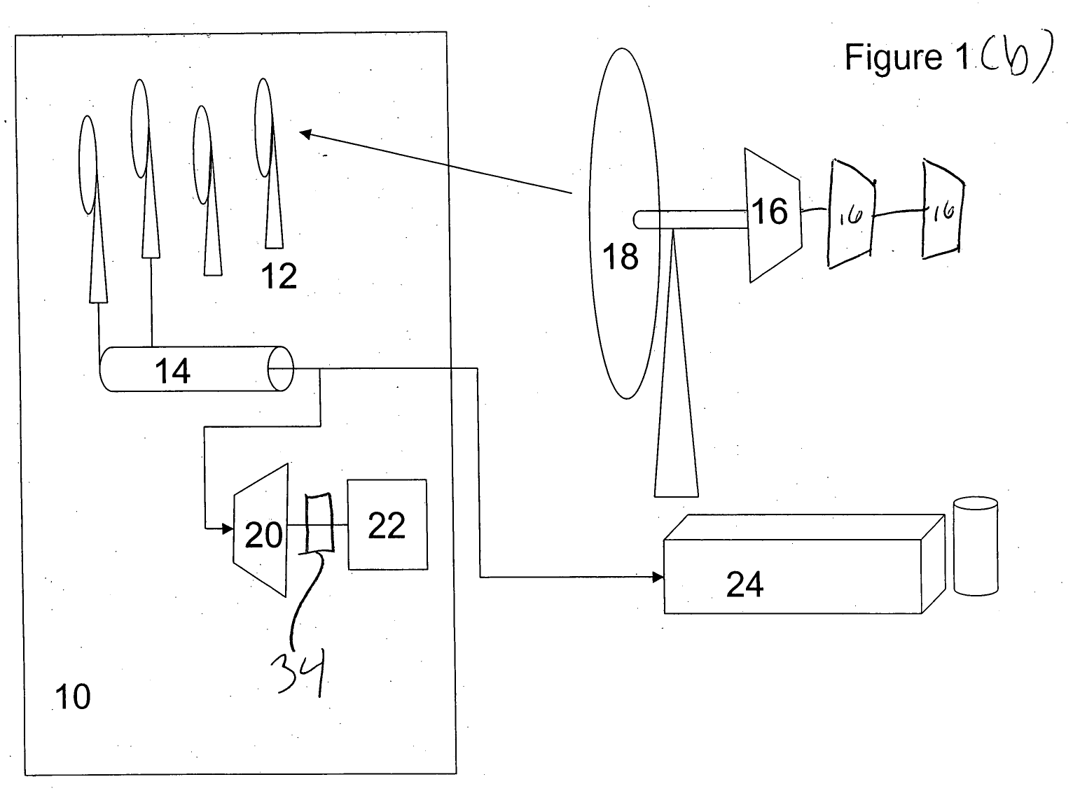

Referring to FIG. 1(a), one embodiment of the present invention is a wind energy generating and storage system, generally denoted as 10, that has one or more direct compression windmill stations 12 with pneumatic motors. An intercooler 13 can be included. Direct compression is direct rotational motion of a shaft or a rotor coupled to one or more compressors. A storage device 14 is coupled to the windmill station 12. At least a first compressor 16 is coupled to the storage device to compress or liquefy air or to drive any process to make liquefied air. The compressor 16 has a fluid intake opening and a fluid exhaust opening. Rotation of a turbine 18 drives the compressor 16. At least one expander 20 is configured to release compressed or liquid air from the storage device 14. A generator 22 is configured to convert the compressed or liquid air energy into electrical energy.

In various embodiments, the compressor 16 operates at a pressure of about, 10 to 100 atmospheres at the fluid exhaust opening, 20 to 100 atmospheres, 10 to 80 atmospheres and the like. In various embodiments, the compressor has a minimum operating pressure for power storage of at least 20 atmospheres, has a peak pressure to low pressure ratio of about 10/1, has a peak pressure to low pressure ratio of about 5/1 and the like.

Thermal energy can be added to the expander 20 at one of, into an interior of the expander, at an intake to the expander and at an outflow at the expander. The thermal energy added to the expander 20 can be, dry air, humid air, wet steam and dry steam, and the like. The expander 20 can be used to expand at least a portion of the wind energy and at least a portion of thermal energy from the thermal energy system. Suitable expanders 20 include but are not limited to, reciprocating, rotary, roots-blower, single screw, twin screw, or diaphragm expander, natural gas turbine, intersecting vein machine, torroidal intersecting vein machine and the like. The expander 20 is coupled to at least a portion of the plurality of direct compression windmill stations to produce electricity. Rotational energy of the expander 20 is an input to the generator 22 to make the electricity. In one embodiment, at least a portion of the energy from the wind energy system 10 and the thermal energy system is dispatchable.

The delivery of wind energy can be coordinated and stabilized. An energy delivery schedule can be created from the wind energy system in response to predictions for wind speed, wind power availability levels, historical, current and anticipated power and green energy prices, and historical, current and anticipated transmission availability. The delivery schedule can be used to match a customer's anticipated demand. The delivery schedule can manage updates and corrections to schedules on very short notice. The delivery schedule can be used to set a reduced number of constant power output periods during an upcoming period of time. By way of illustration, during the upcoming period of time energy, delivery levels can remain substantially constant despite fluctuations and oscillations in wind speed and wind power availability levels.

The upcoming period of time can be any period of time such as the next 24-hour period. In one embodiment, no more than seven constant power output periods during any given 24-hour period would be scheduled. The delivery schedule can take into account the amount of energy that can be supplied directly from the wind power system as well as stored energy. In one embodiment, the delivery schedule is utilized to determine an amount of energy that can be provided from storage, and an amount of power expected to be used and withdrawn by a power grid. In another embodiment, the delivery schedule is utilized to assist in ensuring that wind energy is available at constant power output levels even when the wind energy availability levels drop below a demand for power needed by a power grid.

In another embodiment, at least one demand history is created for a location to help forecast and predict how much energy will be used at the location during an upcoming period of time. Energy availability from the wind energy system can be determined. The demand history can be used for delivery of wind energy to the location. The demand history can be used for delivery of wind energy to the location to manage load, offset spikes, sags, and surges, and meet the needs of the grid and the customer.

The wind energy system can be coupled to a power grid that can be accessed to supply energy into storage by using electricity to run the generator/expanders backwards as motor/compressors to pressurize the system, which will then be expanded on demand to make electricity.

An energy usage schedule can be developed using forecasts and predictions to for the upcoming time period to determine how energy from storage should be used to achieve a desired cost savings. A demand charge can be determined that may be applied based on spikes or surges that can occur during the upcoming time period, and an energy usage schedule then developed to reduce and/or offset the spikes or surges in a manner that achieves cost savings at a location. The location can be a commercial property end-user of energy and storage of energy is used to lower overall costs of energy at the commercial property end-use, and the like.

In one embodiment, an estimated cost savings for the upcoming time period is determined, and then that determination is repeated for an extended period of time, to help determine an overall cost savings that can be achieved during the extended period of time.

In one embodiment, at least a portion of the electrical energy, vacuum pressure, compressed air, heat from compression and liquid air or another compressed fluid from the system 10 is dispatchable to a production facility 24.

Suitable production facilities 24 include but are not limited to, an aluminum production facility, a fertilizer, ammonia, or urea production facility, a liquid air product production facility that can be used in manufacturing liquid air, liquid oxygen, liquid nitrogen, and other liquid air products, a fresh water from desalination production facility, a ferrosilicon production facility, an electricity intensive chemical process or manufacturing facility, a tire recycling plant, coal burning facility, biomass burning facility, medical facility, cryogenic cooling process, or any plant that gasifies liquid oxygen, nitrogen, argon, CO₂, an ethanol production facility, a food processing facility. Examples of food processing facilities include but are not limited to, dairy or meat processing facilities and the like.

In one embodiment, electricity provided by the system 10 is used to electrolyze water at the production facility 24. In another embodiment, the system 10 is configured to provide pressure used at the production facility 24 to drive a reverse or forward osmosis process. In another embodiment, the system 10 is configured to provide at least one of vacuum or heat to drive a distillation process at the production facility 24. In one embodiment, the compressor 16 compresses fluid that is evaporating from fluid in a distillation process. In another embodiment, compressed fluid that is evaporating from a distillation process is returned to exchange its heat with liquid in an evaporation or distillation process

The production or processing facility 24 can be co-located with the system 10.

In one embodiment, the system 10 is configured to receive waste heat from the production facility 24 and utilize at least a portion of the waste heat to provide the electrical energy that is dispatched to the production facility 24. By way of illustration, and without limitation, the system 10 provides electricity for the reduction of carbon dioxide or water and can pressurize carbon dioxide to provide power to electrolyze the carbon dioxide to separate carbon from oxygen. The system 10 can be used to pressurize carbon dioxide and water to a supercritical state and provide power for reaction of these components to methanol. Hydrogen can be introduced to the carbon to create hydrocarbon fuels. The oxygen can be utilized to oxy-fire coal, process iron ore, burn col, process iron ore and the like.

The system 10 can be used to provide a vacuum directly to the production facility 24. This could assist, for example, in the production of products at low temperature distillation facilities, such as fresh water at desalination plants.

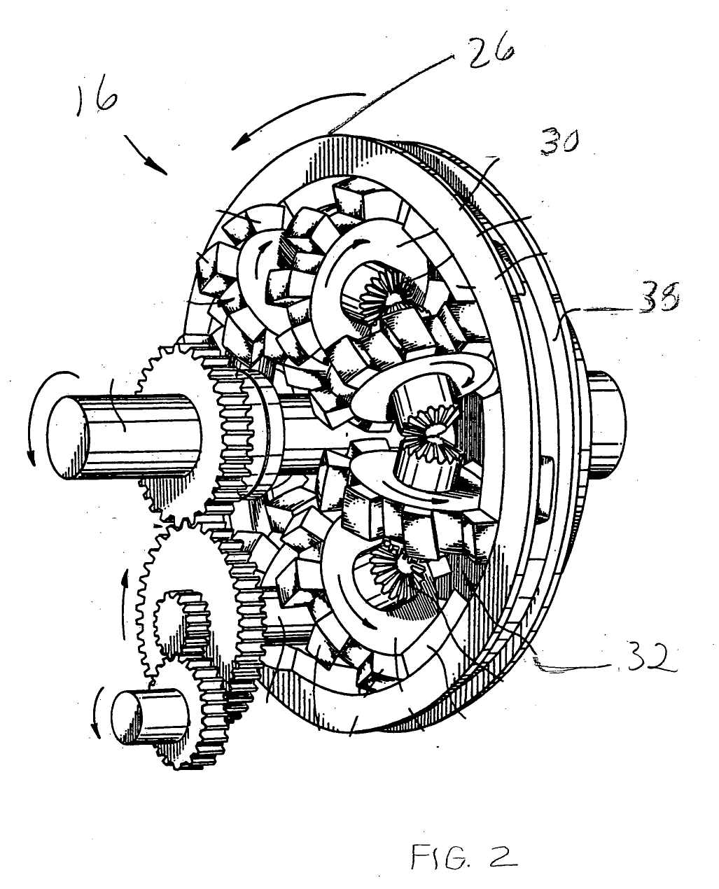

By way of illustration, and without limitation, as shown in FIG. 2 the toroidal intersecting vane compressor 16 includes a supporting structure 26, a first and second intersecting rotors 28 and 30 rotatably mounted in the supporting structure 26. The first rotor 28 has a plurality of primary vanes positioned in spaced relationship on a radially inner peripheral surface of the first rotor 28. The radially inner peripheral surface of the first rotor 28 and a radially inner peripheral surface of each of the primary vanes can be transversely concave, with spaces between the primary vanes and the inside surface to define a plurality of primary chambers 32. The second rotor 30 has a plurality of secondary vanes positioned in spaced relationship on a radially outer peripheral surface of the second rotor. The radially outer peripheral surface of the second rotor 30 and a radially outer peripheral surface of each of the secondary vanes can be transversely convex. Spaces between the secondary vanes and the inside surface define a plurality of secondary chambers 32. A first axis of rotation of the first rotor 28 and a second axis of rotation of the second rotor 30 are arranged so that the axes of rotation do not intersect. The first rotor 28, second rotor 30, primary vanes and secondary vanes are arranged so that the primary vanes and the secondary vanes intersect at only one location during their rotation. The toroidal intersecting vane compressor 16 can be self-synchronizing.

In one embodiment, the turbine 18 is configured to power the compressor(s) 16. For example, the turbine 18 can drive the compressor 16 by a friction wheel drive which is frictionally connected to the turbine 18 and is connected by a belt, a chain, or directly to a drive shaft or gear of the compressor 16. The compressed air can be heated or cooled. The compressed air can be heated or cooled while maintaining substantially constant volume. The compressed air can be heated or cooled while maintaining substantially constant pressure. The compressed air can be heated or cooled by a heat source selected from at least one of the following: solar, ocean, river, pond, lake, other sources of water, power plant effluent, industrial process effluent, combustion, nuclear, and geothermal energy.

The expander 20 can operate independently of the turbine 18 and the compressor 16. The expander 20 and compressor 16 can be approximately the same or different sizes.

A heat exchanger 34 can be provided and coupled to an expander exhaust opening. At least a portion of the compressed air energy can be used as a coolant.

In one specific embodiment, a rotatable turbine 18 is mounted to a mast. In one embodiment, as mentioned above, a toroidal intersecting vane compressor (TIVC) 16 is used. The TIVC is characterized by a fluid intake opening and a fluid exhaust opening, wherein the rotation of the turbine 18 drives the compressor 16. The system 10 permits good to excellent control over the hours of electrical power generation, thereby maximizing the commercial opportunity and meeting the public need during hours of high or peak usage. Additionally, the system 10 minimizes and can avoid the need to place an electrical generator 22 off-shore. The system 10 allows for an alternative method for transmission of power over long distance. Further, the system 10 can be operated with good to excellent efficiency rates.

In one embodiment, a generator apparatus 22 includes, (a) a rotatable turbine 18 mounted to a mast, (b) at least one toroidal intersecting vane compressor 16 characterized by a fluid intake opening and a fluid exhaust opening, wherein the rotation of the turbine 18 drives the compressor 16; (c) a conduit having a proximal end and a distal end wherein the proximal end is attached to the fluid exhaust opening; (d) at least one toroidal intersecting vane expander 20 characterized by a fluid intake opening attached to the distal end; (e) an electrical generator 22 operably attached to the expander 20 to convert rotational energy into electrical energy, and to connect the generator 22 to one or more customers or the electric grid to sell the electricity.

The turbine 18 can be powered to rotate by a number of means apparent to the person of skill in the art. One example is air flow, such as is created by wind. In this embodiment, the turbine 18 can be a wind turbine, such as those well known in the art. One example of a wind turbine is found in U.S. Pat. No. 6,270,308, which is incorporated herein by reference. Because wind velocities are particularly reliable off shore, the turbine 18 can be configured to stand or float off shore, as is known in the art. In yet another embodiment, the turbine 18 can be powered to rotate by water flow, such as is generated by a river or a dam.

As mentioned above, the compressor 16 is preferably a toroidal intersecting vane compressor 16, such as those described in Chomyszak U.S. Pat. No. 5,233,954, issued Aug. 10, 1993 and Tomcyzk, U.S. patent application Publication No. 2003/0111040, published Jun. 19, 2003. The contents of the patent and publication are incorporated herein by reference in their entirety. In a particularly preferred embodiment, the toroidal intersecting vane compressor 16 and elements of the system 10, are found in U.S. Publications Nos. 2005132999, 2005133000 and 20055232801, each incorporated herein fully by reference.

In one embodiment, two or more toroidal intersecting vane compressors 16 are utilized. The compressors 16 can be configured in series or in parallel and/or can each be single stage or multistage compressors 16, as illustrated in FIG. 1(b). The compressor 16 will generally compress air, however, other environments or applications may allow other compressible fluids to be used.

The air exiting the compressor 16 through the compressor exhaust opening will directly or indirectly fill a conduit. Multiple turbines 18, and their associated compressors 16, can fill the same or different conduits. For example, a single conduit can receive the compressed air from an entire wind turbine farm, windplant or windpower facility. Alternatively or additionally, the “wind turbine farm” or, the turbines 18 therein, can fill multiple conduits. The conduit(s) can be used to collect, store, and/or transmit the compressed fluid, or air. Depending upon the volume of the conduit, large volumes of compressed air can be stored and transmitted. The conduit can direct the air flow to a storage vessel or tank or directly to the expander 20. The conduit is preferably made of a material that can withstand high pressures, such as those generated by the compressors 16. Further, the conduit should be manufactured out of a material appropriate to withstand the environmental stresses. For example, where the wind turbine 18 is located off shore, the conduit should be made of a material that will withstand seawater, such as pipelines that are used in the natural gas industry.

The compressed air can be heated or cooled in the conduit or in a slip, or side, stream off the conduit or in a storage vessel or tank. Cooling the fluid can have advantages in multi-stage compressing. Heating the fluid can have the advantage of increasing the energy stored within the fluid, prior to subjecting it to an expander 20. The compressed air can be subjected to a constant volume or constant pressure heating or cooling. The source of heating can be passive or active. For example, sources of heat include solar, ocean, river, pond, lake, other sources of water, power plant effluent, industrial process effluent, combustion, nuclear, and geothermal energy. The conduit, or compressed air, can be passed through a heat exchanger to cool waste heat, such as can be found in power plant streams and effluents and industrial process streams and effluents (e.g., liquid and gas waste streams). In yet another embodiment, the compressed air can be heated via combustion.

Like the TIVC, the expander 20 is preferably a toroidal intersecting vane expander 20 (TIVE), such as those described by Chomyszak, referenced above. Thus, the toroidal intersecting vane expander 20 can comprise a supporting structure, a first and second intersecting rotors rotatably mounted in the supporting structure, the first rotor having a plurality of primary vanes positioned in spaced relationship on a radially inner peripheral surface of the first rotor with the radially inner peripheral surface of the first rotor and a radially inner peripheral surface of each of the primary vanes being transversely concave, with spaces between the primary vanes and the inside surface defining a plurality of primary chambers, the second rotor having a plurality of secondary vanes positioned in spaced relationship on a radially outer peripheral surface of the second rotor with the radially outer peripheral surface of the second rotor and a radially outer peripheral surface of each of the secondary vanes being transversely convex, with spaces between the secondary vanes and the inside surface defining a plurality of secondary chambers, with a first axis of rotation of the first rotor and a second axis of rotation of the second rotor arranged so that the axes of rotation do not intersect, the first rotor, the second rotor, primary vanes and secondary vanes being arranged so that the primary vanes and the secondary vanes intersect at only one location during their rotation. Similarly, the toroidal intersecting vane expander 20 is self-synchronizing. Like the TIVC, the expanders 20 can be multistage or single stage, used alone, in series or in parallel with additional TIVEs. A single TIVE can service a single conduit or multiple conduits.

One of the advantages of the present invention is the ability to collect the compressed air or other fluid and convert the compressed air or fluid to electricity independently of each other. As such, the electricity generation can be accomplished at a different time and in a shorter, or longer, time period, as desired, such as during periods of high power demand or when the price of the energy is at its highest.

As such, the expander 20 is preferably configured to operate independently of the turbine 18 and compressor 16. Further, because the conduit that is directing the compressed fluid, or air, to the expander 20 can be of a very large volume, the expander 20 need not be located proximally with the turbine 18 and compressor 16. As such, even where the wind turbine 18 is located off shore, the expander 20 can be located on land, such as at a power plant, thereby avoiding the need to transmit electricity from the wind farm to the grid or customer.

Further, the sizes and capacities of the TIVCs and TIVEs can be approximately the same or different. The capacity of the TIVE is preferably at least 0.5 times the capacity of the TIVCs it services, preferably the capacity of the TIVE exceeds the capacity of the TIVCs it services. Generally, the capacity of the TIVE is between about 1 and 5 times the capacity of the TIVCs it serves. For example, if 100 turbines 18, with 100 TIVCs, each have a capacity of 2 megawatts, a TIVE that services all 100 turbines 18, preferably has the capacity to produce 100 megawatts, preferably at least about 200 to 1,000 megawatts. Of course, TIVEs and TIVCs of a wide range of capacities can be designed.

Additional modifications to further improve energy usage can be envisioned from the apparatus of the invention. Energy recycle streams and strategies can be easily incorporated into the apparatus. For example, the expanded fluid exiting from the expander 20 will generally be cold. This fluid can be efficiently used as a coolant, such as in a heat exchanger.

The dimensions and ranges herein are set forth solely for the purpose of illustrating typical device dimensions. The actual dimensions of a device constructed according to the principles of the present invention may obviously vary outside of the listed ranges without departing from those basic principles.

Further, it should be apparent to those skilled in the art that various changes in form and details of the invention as shown and described may be made. It is intended that such changes be included within the spirit and scope of the claims appended hereto.

1. A wind energy generating and storage system, comprising:
a direct compression windmill station that includes a pneumatic motor, wherein direct compression is direct rotational motion of a shaft or a rotor coupled to one or more compressors;
a storage device coupled to the windmill station;
at least a first compressor coupled to the storage device to compress or liquefy air, or to drive any process to make liquefied air, the compressor having a fluid intake opening and a fluid exhaust opening, wherein rotation of a turbine drives the compressor;
at least one expander configured to release compressed or liquid air from the storage device; and
a generator configured to convert the compressed or liquid air energy into electrical energy.

2. The system of claim 1, wherein the compressor operates at a pressure of about 10 to 100 atmospheres.

3. The system of claim 1, wherein the compressor operates at a pressure of about 20 to 100 atmospheres.

4. The system of claim 1, wherein the compressor operates at a pressure of about 10 to 80 atmospheres.

5. The system of claim 1, wherein the compressor has a minimum operating pressure for power storage of at least 20 atmospheres.

6. The system of claim 1, wherein the compressor has a peak pressure to low pressure ratio of about 10/1.

7. The system of claim 1, wherein the compressor has a peak pressure to low pressure ratio of about 5/1.

8. The system of claim 1, wherein at least a portion of at least one of, electrical energy, vacuum pressure, compressed air, heat from compression and liquid air or another compressed fluid is dispatchable to a production facility.

9. The system of claim 8, wherein the production facility is an aluminum production facility.

10. The system of claim 8, wherein the production facility is a fertilizer, ammonia, or urea production facility.

11. The system of claim 8, where the production facility is an ethanol production facility

12. The system of claim 8, wherein the production facility is a food processing facility.

13. The system of claim 12, wherein the food processing facility is a dairy or meat processing facility

14. The system of claim 8, wherein the production facility is a liquid air product production facility for use in manufacturing at least one, liquid air, liquid oxygen, liquid nitrogen, and other liquid air products.

15. The system of claim 8, wherein the production facility is a fresh water desalination production facility.

16. The system of claim 8, wherein electricity provided by the system is used to electrolyze water at the production facility.

17. The system of claim 8, wherein the system is configured to provide pressure used at the production facility to drive a reverse or forward osmosis process.

18. The system of claim 8, wherein the system is configured to provide at least one of vacuum or heat to drive a distillation process at the production facility.

19. The system of claim 8, wherein the compressor compresses fluid that is evaporating from fluid in a distillation process

20. The system of claim 8, wherein compressed fluid that is evaporating from a distillation process is returned to exchange its heat with liquid in an evaporation or distillation process

21. The system of claim 8, wherein the production facility is a ferrosilicon production facility.

22. The system of claim 8, wherein the system is configured to receive waste heat from the production facility and utilize at least a portion of the waste heat to provide electrical energy that is dispatched to the production facility.

23. The system of claim 8, wherein the system is configured to provide coolant to the production facility.

24. The system of claim 8, wherein the system provides electricity for the reduction of carbon dioxide or water.

25. The system of claim 8, wherein the system is configured to pressurize carbon dioxide and provide power to electrolyze the carbon dioxide to separate carbon from oxygen.

26. The system of claim 8, wherein the system is configured to pressurize carbon dioxide and water to a supercritical state and provide power for reaction of these components to methanol.

27. The system of claim 26, further comprising:
introducing hydrogen to the carbon to create hydrocarbon fuels.

28. The system of claim 26, wherein the oxygen is utilized to oxy-fire coal.

29. The system of claim 26, wherein the oxygen is utilized to burn coal or process iron ore.

30. The system of claim 8, wherein the system is configured to provide a vacuum directly to the production facility.

31. The system of claim 1, wherein the compressor is a toroidal intersecting vane compressor.

32. The system of claim 1, wherein the toroidal intersecting vane compressor includes a supporting structure, a first and second intersecting rotors rotatably mounted in said supporting structure, said first rotor having a plurality of primary vanes positioned in spaced relationship on a radially inner peripheral surface of said first rotor with said radially inner peripheral surface of said first rotor and a radially inner peripheral surface of each of said primary vanes being transversely concave, with spaces between said primary vanes and said inside surface defining a plurality of primary chambers, said second rotor having a plurality of secondary vanes positioned in spaced relationship on a radially outer peripheral surface of said second rotor with said radially outer peripheral surface of said second rotor and a radially outer peripheral surface of each of said secondary vanes being transversely convex, with spaces between said secondary vanes and said inside surface defining a plurality of secondary chambers, with a first axis of rotation of said first rotor and a second axis of rotation of said second rotor arranged so that said axes of rotation do not intersect, said first rotor, said second rotor, primary vanes and secondary vanes being arranged so that said primary vanes and said secondary vanes intersect at only one location during their rotation.

33. The system of claim 31, wherein the toroidal intersecting vane compressor is self-synchronizing.

34. The system of claim 1, wherein the turbine drives the compressor by a friction wheel drive which is frictionally connected to the turbine and is coupled to the compressor.

35. The system of claim 1, wherein the compressed air can be heated or cooled.

36. The system of claim 1, wherein the compressed air is heated while maintaining a constant volume.

37. The system of claim 1, wherein the compressed air is heated while maintaining a constant pressure.

38. The system of claim 1, wherein the compressed air is heated by a heat source selected from at least one of, solar, ocean, river, pond, lake, power plant effluent, industrial process effluent, combustion, nuclear, biomass, and geothermal energy.

39. The system of claim 1, wherein the expander is configured to operate independently of the turbine and the compressor.

40. The system of claim 1, wherein the expander and compressor are the approximately the same or different sizes.

41. The system of claim 1, further comprising:
a heat exchanger coupled to an expander exhaust opening, wherein at least a portion of the compressed air energy is used as a coolant.

42. A method of production, comprising:
collecting wind energy from a direct compression windmill station that includes a pneumatic motor, wherein direct compression is direct rotational motion of a shaft or a rotor coupled to one or more compressors;
compressing or liquefying air from the wind energy utilizing a compressor;
utilizing an expander to release compressed or liquid air;
converting the compressed or liquid air energy into electrical energy.

43. The method of claim 42, further comprising:
operating a compressor at a pressure of 10 to 100 atmospheres at a fluid exhaust opening.

44. The method of claim 42, further comprising:
operating a compressor at a pressure of about 10 to 80 atmospheres at a fluid exhaust opening.

45. The method of claim 42, further comprising:
operating a compressor at a pressure of about 20 to 100 atmospheres at a fluid exhaust opening.

46. The method of claim 42, further comprising:
operating a compressor with a minimum operating pressure for power storage of at least 20 atmospheres.

47. The method of claim 42, further comprising:
operating a compressor that has a peak pressure to low pressure ratio of about 10/1.

48. The method of claim 42, further comprising:
operating a compressor that has a peak pressure to low pressure ratio of about 5/1.

49. The method of claim 42, further comprising:
dispatching at least a portion of the electrical energy to a production facility.

50. The method of claim 49, wherein the production facility is selected from at least one of, an aluminum production facility, a fertilizer, ammonia, or urea production facility, a liquid air product production facility that can be used in manufacturing liquid air, liquid oxygen, liquid nitrogen, and other liquid air products, a fresh water from desalination production facility, a ferrosilicon production facility, an electricity intensive chemical process or manufacturing facility, a tire recycling plant, coal burning facility, biomass burning facility, medical facility, cryogenic cooling process, or any plant that gasifies liquid oxygen, nitrogen, argon, CO₂, an ethanol production facility and a food processing facility.

51. The method of claim 49, further comprising:
providing electricity to electrolyze water at the production facility.

52. The method of claim 49, further comprising:
providing pressure used at the production facility to drive a reverse or forward osmosis process.

53. The method of claim 49, further comprising:
providing at least one of vacuum or heat to drive a distillation process at the production facility.

54. The method of claim 42, further comprising:
utilizing the compressor to compresses fluid that is evaporating from fluid in a distillation process

55. The method of claim 42, further comprising:
returning compressed fluid that is evaporating from a distillation process to exchange its heat with liquid in an evaporation or distillation process.

56. The method of claim 49, further comprising:
receiving waste heat from the production facility; and
utilizing at least a portion of the waste heat to provide electrical energy that is dispatched to the production facility.

57. The method of claim 49, further comprising:
providing coolant to the production facility.

58. The method of claim 42, further comprising:
providing electricity for a reduction of carbon dioxide or water.

59. The method of claim 42, further comprising:
pressurizing carbon dioxide; and
providing power to electrolyze the carbon dioxide to separate carbon from oxygen.

60. The method of claim 42, further comprising:
pressurizing carbon dioxide and water to a supercritical state; and
providing power for reaction of these components to methanol.

61. The method of claim 59, further comprising:
introducing hydrogen to the carbon to create hydrocarbon fuels.

62. The method of claim 59, further comprising:
utilized the oxygen to oxy-fire coal.

63. The method of claim 59, further comprising:
utilizing the oxygen to burn coal or process iron ore.

64. The method of claim 49, further comprising:
providing a vacuum directly to the production facility.

65. The method of claim 49, further comprising:
coordinating and stabilizing the delivery of wind energy.

66. The method of claim 49, further comprising:
creating an energy delivery schedule from the wind energy system in response to predictions for wind speed and wind power availability levels.

67. The method of claim 66, further comprising:
using the delivery schedule to set a reduced number of constant power output periods during an upcoming period of time.

68. The method of claim 67, wherein during the upcoming period of time energy delivery levels can remain substantially constant despite fluctuations and oscillations in wind speed and wind power availability levels.

69. The method of claim 67, wherein the upcoming period of time is the next 24 hour period.

70. The method of claim 69, further comprising:
setting no more than seven constant power output periods during any given 24 hour period.

71. The method of claim 67, wherein the delivery schedule takes into account the amount of energy that can be supplied directly from the wind power system as well as stored energy.

72. The method of claim 67, wherein the delivery schedule is utilized to determine an amount of energy that can be provided from storage, and an amount of power expected to be used and withdrawn by a power grid.

73. The method of claim 67, wherein the delivery schedule is utilized to assist in ensuring that wind energy is available at constant power output levels even when the wind energy availability levels drop below a demand for power needed by a power grid.

74. The method of claim 42, further comprising:
creating at least one demand history for a location to help forecast and predict how much energy will be used at the location during an upcoming period of time.

75. The method of claim 74, further comprising:
determining when energy will be available from the wind energy system.

76. The method of claim 75, further comprising:
using the demand history for delivery of wind energy to the location.

77. The method of claim 76, further comprising:
using the demand history for delivery of wind energy to the location to offset spikes or surges at the location.

78. The method of claim 74, wherein the wind energy system is coupled to a power grid that can be accessed to supply energy into storage.

79. The method of claim 1, further comprising:
using forecasts and predictions to develop an energy usage schedule for the upcoming time period to determine how energy from storage should be used to achieve a desired cost savings.

80. The method of claim 74, further comprising:
determining a demand charge that may be applied based on spikes or surges that can occur during the upcoming time period and developing an energy usage schedule to reduce and/or offset the spikes or surges in a manner that achieves cost savings.

81. The method of claim 74, wherein the location is a commercial property end-user of energy and storage of energy is used to lower overall costs of energy at the commercial property end-use.

82. The method of claim 74, wherein an estimated cost savings for the upcoming time period is determined, and then that determination is repeated for an extended period of time, to help determine an overall cost savings that can be achieved during the extended period of time.

83. The method of claim 74, wherein the wind energy is stored by at least one of, a solar thermal collector, thermal inertia mass, thin walled tubing with anti-freeze distributed inside the tank, fossil fuel burner, and a circulation device for using hot air.

84. The method of claim 74, wherein an energy storage system is provided that is configured to use cold air from a turbo-expander for cooling and/or refrigeration purposes at the location.
